(19) United States
(12) Patent Application Publication
(10) Pub. No.: US 2012/0218258 A1
(43) Pub. Date: Aug. 30, 2012

(54) DISPLAY APPARATUS

(75) Inventor: Ken MASHITANI, Neyagawa-City (JP)

(73) Assignee: SANYO ELECTRIC CO., LTD, Moriguchi-shi (JP)

(21) Appl. No.: 13/404,312

(22) Filed: Feb. 24, 2012

(30) Foreign Application Priority Data
Feb. 28, 2011 (JP) 2011-042743

(51) Int. Cl. G06T 15/00

(52) U.S. Cl. 345/419

(57) ABSTRACT

A display apparatus that displays a three dimensional image configured by a plurality of viewpoint images, the display apparatus comprising: an image display unit having a plurality of pixels arranged in horizontal and vertical directions; and an image control unit that controls the image display unit, wherein each of the plurality of pixels includes a plurality of sub-pixels arranged in the vertical direction, and the image control unit controls the image display unit so as to sequentially display a plurality of the viewpoint images along the horizontal direction, using a plurality of pixel units, provided that each of the pixel units is regarded as a single unit configured by a plurality of pixels neighboring the horizontal direction.

### CROSS REFERENCE TO RELATED APPLICATIONS

This application claims priority of Japanese Patent Application No. 2011-042743 filed on Feb. 28, 2011. The contents of this application are incorporated herein by reference in their entirety.

### BACKGROUND OF THE INVENTION

1. Field of the Invention

The present invention relates to a display apparatus that displays a three dimensional image configured by a plurality of viewpoint images.

2. Description of the Related Art

Conventionally, there is known a three dimensional image configured by a plurality of viewpoint images. Among a plurality of viewpoint images, parallax exists. Here, in each viewpoint image, an object is captured using image pick-up devices arranged in a plurality of viewpoint positions (for example, a left-eye viewpoint position and a right-eye viewpoint image).

For example, there is known a technique in which pixels configuring the left-eye viewpoint image and pixels configuring the right-eye viewpoint image are alternately displayed along the horizontal direction and an image separation unit such as a parallax barrier or a lenticular lens is used (For example, Japanese Patent Application Publication No. 2004-144792). In addition, a single pixel is configured by a plurality of sub-pixels such RGB.

Here, the display apparatus that displays the three dimensional image includes an image display unit, a substrate, and an image separation unit. The “substrate” may include a glass substrate (substrate A) forming the image display unit and a glass substrate (substrate B) forming the image separation unit. In the substrate B, if a configuration serving as the image separation unit (for example, a slit portion in the case of a parallax barrier) is arranged at the side of the image display unit, the substrate A is the “substrate”. Meanwhile, in the substrate B, if a configuration serving as the image separation unit (for example, a slit portion in the case of a parallax barrier) is arranged at the side of an observer, the substrate A and the substrate B are the “substrate”. The image display unit is provided on a principal surface at the side far from an observer out of the principal surfaces of the substrate. Meanwhile, the image separation unit is provided on a principal surface at the side near the observer out of the principal surfaces of the substrate.

In the following description, “E” denotes an interocular distance (that is, an interfocal distance) of an observer, “d” denotes a thickness of the substrate, “P” denotes an inter-pixel distance, and “D” denotes a distance from the eye of an observer to the substrate (hereinafter, referred to as an observation distance).

In such a case, in order that an observer visually recognizes a three dimensional image, the observation distance needs to satisfy a relationship of D=d×E/P. Therefore, to shorten the observation distance “D”, it is envisaged to (1) decrease the interocular distance “E”, (2) decrease the thickness “d” of the substrate, or (3) increase the inter-pixel distance “P”.

For example, there has been proposed a technique of using sub-pixels (hereinafter, referred to as a horizontally-long sub-pixel) having a horizontal size larger than a vertical size in order to increase the inter-pixel distance “P.”

However, it is assumed that in a small-sized terminal such as a mobile telephone, it is not possible to sufficiently shorten the observation distance “D” even when the horizontally-long sub-pixel is used.

### SUMMARY OF THE INVENTION

A display apparatus of a first feature displays a three dimensional image configured by a plurality of viewpoint images. The display apparatus comprising: an image display unit (image display unit 10) having a plurality of pixels arranged in horizontal and vertical directions; and an image control unit (image control unit 20) that controls the image display unit. Each of the plurality of pixels includes a plurality of sub-pixels arranged in the vertical direction. The image control unit controls the image display unit so as to sequentially display a plurality of the viewpoint images along the horizontal direction, using a plurality of pixel units, provided that each of the pixel units is regarded as a single unit configured by a plurality of pixels neighboring the horizontal direction.

In the first feature, each of the plurality of sub-pixels has a horizontal size larger than the vertical size.

In the first feature, the image control unit controls the image display unit so as to display a plurality of the viewpoint images using a particular pixel out of pixels configuring the pixel unit.

In the first feature, the image control unit controls the image display unit so as to display an image indicating whether or not a position of an image separation unit arranged between the image display unit and an observer is correct, using a pixel other than the particular pixel out of pixels configuring the pixel unit.

In the first feature, the image control unit controls the image display unit so as to display an image indicating a direction to which an image separation unit arranged between the image display unit and an observer should be moved, using a pixel other than the particular pixel out of pixels configuring the pixel unit.

### BRIEF DESCRIPTION OF THE DRAWINGS

FIG. 1 is a schematic diagram illustrating a display apparatus 100 according to a first embodiment.

FIG. 2 is a block diagram illustrating the display apparatus 100 according to the first embodiment.

FIG. 3 is a diagram illustrating an image display unit 10 according to the first embodiment.

FIG. 4 is a diagram illustrating an observation distance “D” according to the first embodiment.

FIG. 5 is a diagram illustrating the observation distance “D” according to the first embodiment.

FIG. 6 is a diagram illustrating an exemplary display image according to a first modification.

FIG. 7 is a diagram illustrating an exemplary image display unit 10 according to the first modification.

FIG. 8 is a diagram illustrating position alignment in an image separation unit 30 according to the first modification.

FIG. 9 is a diagram illustrating position alignment in the image separation unit 30 according to the first modification.

FIG. 10 is a diagram illustrating an exemplary display image according to a second modification.

FIG. 11 is a diagram illustrating an exemplary display image according to the second modification.

FIG. 12 is a diagram illustrating an exemplary display image according to the second modification.

FIG. 13 is a diagram illustrating an exemplary display image according to the second modification.

FIG. 14 is a diagram illustrating an exemplary display image according to a third modification.

FIG. 15 is a diagram illustrating the image separation unit 30 according to a fourth modification.

FIG. 16 is a diagram illustrating a pixel unit according to a fifth modification.

FIG. 17 is a diagram illustrating an observation distance “D” according to a sixth modification.

FIG. 18 is a diagram illustrating an observation distance “D” according to the sixth modification.

### BEST MODES FOR CARRYING OUT THE INVENTION

Hereinafter, a display apparatus according to an embodiment of the present invention will be described with reference to the drawings. In the following description of the drawings, the same or similar reference numerals are used to designate the same or similar parts.

### Overview of Embodiments

A display apparatus according to the embodiments displays a three dimensional image configured by a plurality of viewpoint images. The display apparatus includes an image display unit having a plurality of pixels arranged in horizontal and vertical directions and an image control unit configured to control the image display unit. Each of the pixels is configured by a plurality of sub-pixels arranged in the vertical direction. The image control unit controls the image display unit so as to sequentially display a plurality of viewpoint images along the horizontal direction using a plurality of pixel units, provided that each of the pixel units is regarded as a single unit configured by a plurality of pixels neighboring the horizontal direction.

In the embodiments, the image control unit controls the image display unit so as to sequentially display a plurality of viewpoint images along the horizontal direction using a plurality of pixel units. A single pixel unit is configured by a plurality of pixels neighboring the horizontal direction. Therefore, it is possible to shorten the observation distance “D” by increasing the inter-pixel distance “P”.

Note that the display apparatus includes a projection display apparatus, a plasma display, a liquid crystal display, and the like.

Further, it may be assumed that the display apparatus is installed in a mobile terminal, and therefore, the terms such as “horizontal direction” and the “vertical direction” used herein do not strictly match a horizontal direction and a vertical direction depending on a certain mode where the mobile terminal is used. For example, the “horizontal direction” used herein may refer to an extending direction of a line linking the left and right eyes of an observer. For example, the “vertical direction” used herein may refer to a direction perpendicular to the “horizontal direction”.

According to the embodiments, the three dimensional image is configured by a left-eye viewpoint image and a right-eye viewpoint image. The pixels configuring the left-eye viewpoint image and the pixels configuring the right-eye viewpoint image are alternately displayed along the horizontal direction.

### First Embodiment

### (Display Apparatus)

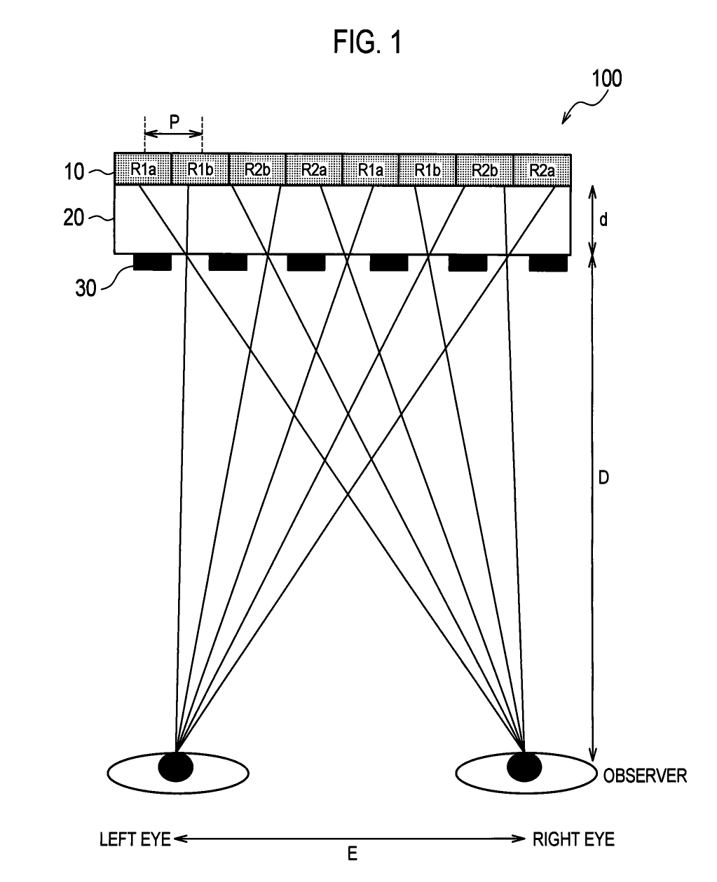

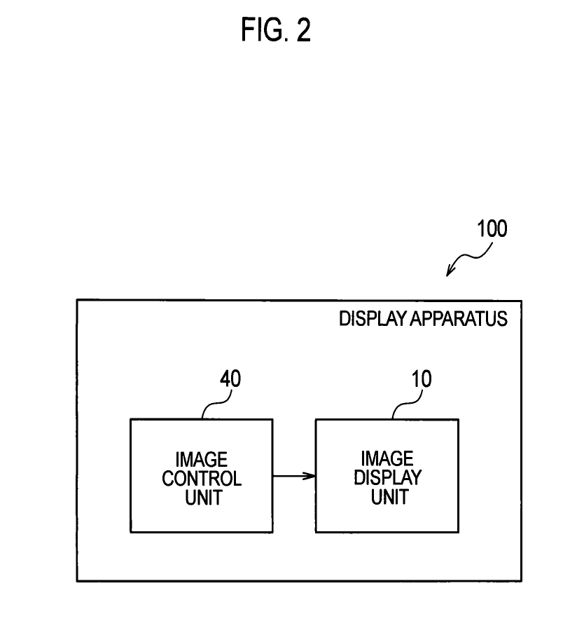

Hereinafter, the display apparatus according to the first embodiment will be described with reference to the accompanying drawings. FIG. 1 is a schematic diagram illustrating the display apparatus 100 according to the first embodiment. FIG. 2 is a block diagram illustrating the display apparatus 100 according to the first embodiment.

As illustrated in FIG. 1, the display apparatus 100 includes an image display unit 10, a substrate 20, and an image separation unit 30.

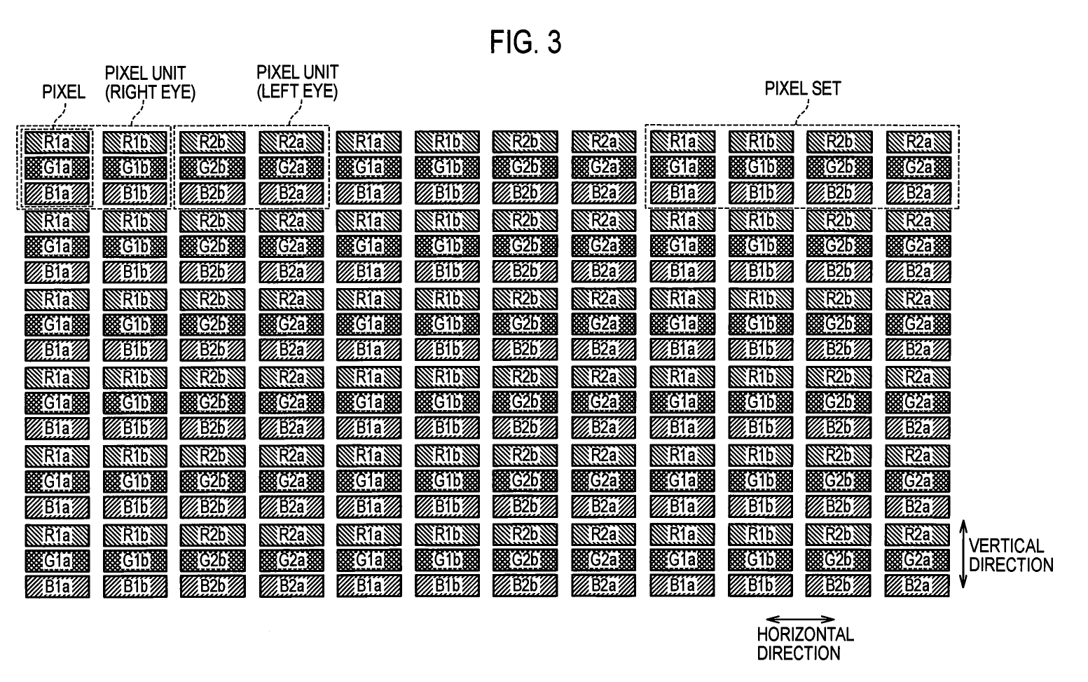

The image display unit 10 is configured by a plurality of pixels. Each of the pixels is configured by a sub-pixel such as RGB. The image display unit 10 is installed on a principal surface at the side far from an observer out of the principal surfaces of the substrate 20. The image display unit 10 will be described in detail below (see FIG. 3).

The substrate 20 is a transparent member such as glass and resin. The substrate 20 may correspond to a touch panel. It should be noted that the thickness of the substrate 20 increases in a case where the substrate 20 corresponds to the touch panel.

The image separation unit 30 separates video light emitted from the pixels configuring the left-eye viewpoint image and video light emitted from pixels configuring the right-eye viewpoint image. The image separation unit 30 is a parallax barrier, a lenticular lens, and the like. Herein, a case where the image separation unit 30 is a parallax barrier is exemplarily provided.

The image separation unit 30 is configured to enable sliding on the principal surface of the substrate 20. In order that an observer visually recognizes the three dimensional image, it is necessary to arrange the image separation unit 30 in an appropriate position by sliding the image separation unit 30.

In the first embodiment, description will be made for a case where “E” denotes the interocular distance of an observer, “d” denotes the thickness of the substrate 20, “P” denotes an inter-pixel distance, and “D” denotes a distance from an observer's eye to the substrate 20 (hereinafter, referred to as an observation distance).

In the first embodiment, “E₁” denotes a distance between focal points (hereinafter, referred to as an interfocal distance) where the video light separated by the image separation unit 30 is focused. Typically, the interfocal distance “E₁” is similar to the interocular distance “E”.

In this case, it should be noted that the observation distance need to satisfy a relationship of D=d×E₁ (≈E)/P in order that an observer visually recognizes the three dimensional image.

As illustrated in FIG. 2, the display apparatus 100 has the image display unit 10 and the image control unit 20.

As described above, the image display unit 10 is configured by a plurality of pixels. Specifically, the image display unit 10 includes a plurality of pixels arranged in horizontal and vertical directions as illustrated in FIG. 3.

Here, a plurality of sub-pixels (for example, three sub-pixels of RGB) arranged in the vertical direction configure a single pixel. A plurality of pixels (here, two pixels) neighboring the horizontal direction configure a single pixel unit. In addition, a plurality of pixel units (here, two pixel units) neighboring the horizontal direction configure a single pixel set.

Of the pixels units neighboring the horizontal direction, the pixels configuring the left-eye viewpoint image are displayed in pixels configuring one of the pixel units. Of the pixels units neighboring the horizontal direction, the pixels configuring the right-eye viewpoint image are displayed in pixels configuring the other pixel unit. That is, the left-eye viewpoint image and the right-eye viewpoint image are sequentially displayed in a plurality of pixel units along the horizontal direction, provided that the pixel unit is regarded as a single unit.

In addition, of the pixels configuring one pixel unit (that is, the pixels neighboring the horizontal direction), one type of pixels belongs a first-type pixel. Of the pixels configuring one pixel unit (that is, the pixels neighboring the horizontal direction), the other type of pixels belongs a second-type pixel.

Here, the first-type pixel that should display the left-eye viewpoint image adjoins the first-type pixel that should display the right-eye viewpoint image. Alternatively, the second-type pixel that should display the left-eye viewpoint image adjoins the second-type pixel that should display the right-eye viewpoint image. That is, provided that pixels having different viewpoints and the same type are regarded as a single unit, the first-type pixel and the second-type pixel are alternately arranged along the horizontal direction. In addition, in the first-type pixel and the second-type pixel, the same image may de displayed and different images may also be displayed.

More specifically, in the first embodiment, the image display unit 10 includes a mode obtained by rotating an FPD (Flat Panel Display)-type pixel arrangement by 90 degrees. Therefore, each of a plurality of sub-pixels configuring a single pixel has a shape where the horizontal size is larger than the vertical size. As a result, the inter-pixel distance “P” increases as compared to the FPD type pixel arrangement.

In the following description, “R” denotes a red sub-pixel, “G” denotes a green sub-pixel, and “B” denotes a blue sub-pixel. In addition, “1” denotes the right-eye pixel, “2” denotes the left-eye pixel, “a” denotes the first-type pixel, and “b” denotes the second-type pixel.

Therefore, “R1a” denotes a red sub-pixel, a right-eye pixel, and a first type. “R2b” denotes a red sub-pixel, a left-eye pixel, and a second type.

In addition, in the first-type pixel and the second-type pixel, the same image may de displayed and different images may also be displayed.

Here, if the same image is displayed in the first-type pixel and the second-type pixel, an observer may visually recognize the three dimensional image by observing the right-eye viewpoint image with the right eye and observing the left-eye viewpoint image with the left eye regardless of the type of the pixel.

Otherwise, if different images are displayed in the first-type pixel and the second-type pixel, an observer may visually recognize the three dimensional image by observing the right-eye viewpoint image with the right eye and observing the left-eye viewpoint image, displayed in the pixel of the same type as that of the pixel where the right-eye viewpoint image is displayed, with the left eye.

The image control unit 20 controls the image display unit 10. Specifically, the image control unit 20 controls the image display unit 10 so as to alternately display a plurality of viewpoint images (including the left-eye viewpoint image and the right-eye viewpoint image) along the horizontal direction using a plurality of pixel units, provided that each of the pixel units is regarded as a single unit.

Here, the image control unit 20 may control the image display unit 10 so as to display a plurality of viewpoint images (including the left-eye viewpoint image and the right-eye viewpoint image) using a particular pixel (for example, the first-type pixel or the second-type pixel) out of pixels configuring the pixel unit. In other words, any one of the first-type pixel and the second-type pixel is the left-eye viewpoint image and the right-eye viewpoint image.

### (Case Where Same Image is Displayed in First-Type Pixel and Second-Type Pixel)

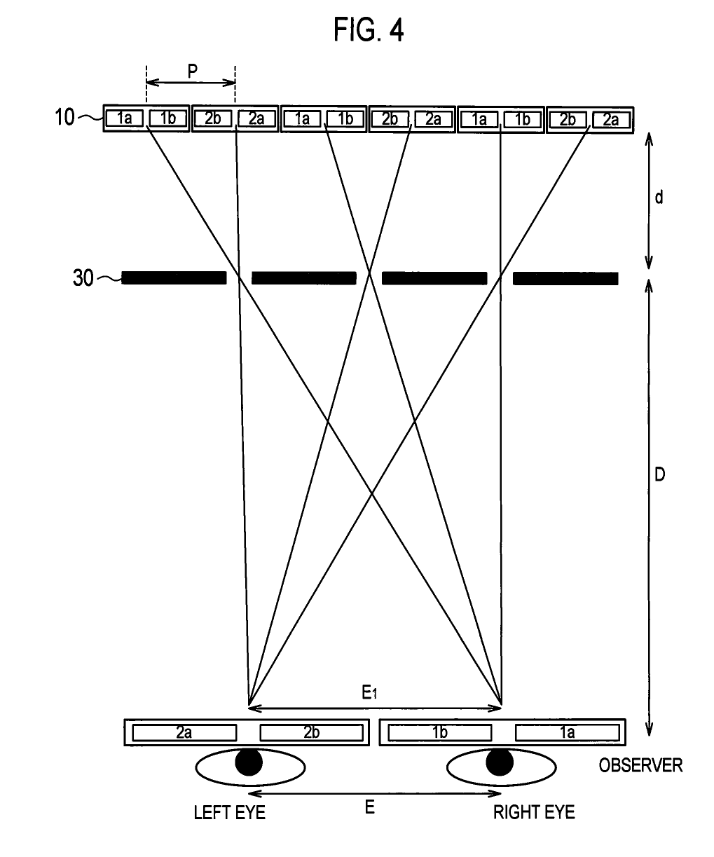

In this case, as illustrated in FIG. 4, the left-eye viewpoint image and the right-eye viewpoint image are sequentially displayed along the horizontal direction, provided that each of the pixel units is regarded as a single unit.

In this case, since a plurality of pixels neighboring the horizontal direction configure a single pixel unit, the inter-pixel distance “P” increases. Therefore, it is possible to decrease the observation distance “D”. However, the interfocal distance “E₁” is equal to the interocular distance “E”.

### (Case Where Different Images are Displayed in First-Type Pixel and Second-Type Pixel)

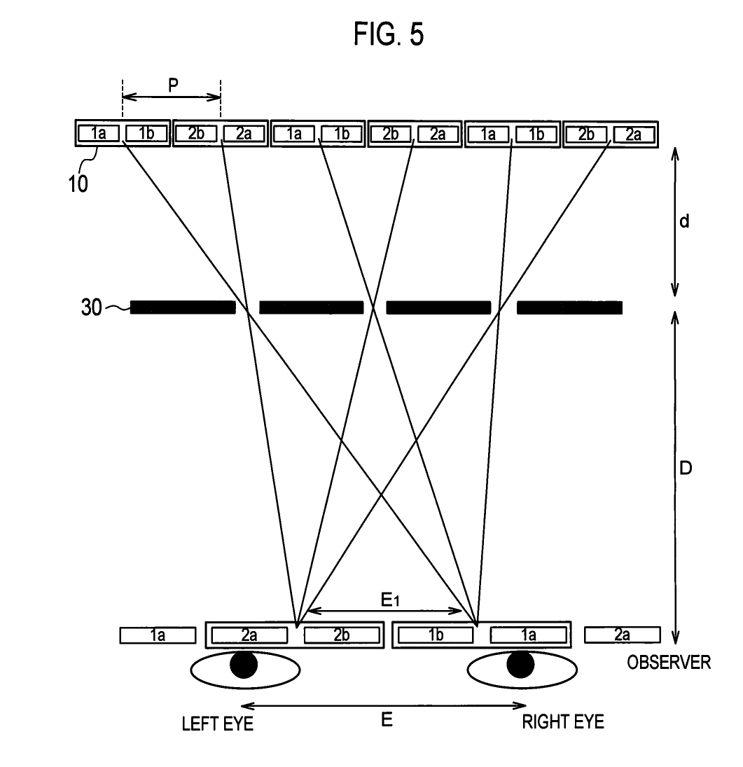

In this case, the left-eye viewpoint image and the right-eye viewpoint image are displayed in a particular pixel (first-type pixel or second-type pixel). Here, description will be exemplarily made for a case where the left-eye viewpoint image and the right-eye viewpoint image are displayed in the first-type pixel. As illustrated in FIG. 5, an observer visually recognizes only the first-type pixel.

In this manner, since an observer visually recognizes only the first-type pixel, the interfocal distance “E₁” is decreased than the interocular distance “E”. For example, the interfocal distance “E₁” is ⅔ of the interocular distance “E”. Therefore, it is possible to decrease the observation distance “D”.

Similar to the case of FIG. 4, the inter-pixel distance “P” increases in the case of FIG. 5. Therefore, it is possible to decrease the observation distance “D”.

### (Operation and Effect)

According to the first embodiment, the image control unit 20 controls the image display unit 10 so as to alternately display a plurality of viewpoint images (including the left-eye viewpoint image and the right-eye viewpoint image) along the horizontal direction using a plurality of pixel units. A single pixel unit is configured by a plurality of pixels neighboring the horizontal direction. Therefore, it is possible to shorten the observation distance “D” by increasing the inter-pixel distance “P”.

According to the first embodiment, the image control unit controls the image display unit 10 so as to display a plurality of viewpoint images (including the left-eye viewpoint image and the right-eye viewpoint image) using a particular pixel (for example, first-type pixel) out of pixels configuring the pixel unit.

Therefore, since an observer visually recognizes a particular pixel out of pixels configuring a single pixel unit, it is possible to decrease the interfocal distance “E” than the interocular distance. In addition, it is possible to shorten the observation distance “D” by reducing the interfocal distance “E”. In this design state, the second-type pixel may display the same image as the image to be displayed in the first-type pixel.

### First Modification

Hereinafter, a first modification of the first embodiment will be described. The following description will be made by focusing on the differences from the first embodiment.

Specifically, in the first embodiment, the image control unit controls the image display unit 10 so as to display a plurality of viewpoint images (including the left-eye viewpoint image and the right-eye viewpoint image) using a particular pixel (for example, the first-type pixel) out of pixels configuring the pixel unit. In comparison, in the first modification, the image control unit controls the image display unit 10 so as to display an image indicating whether or not the position of the image separation unit 30 is correct using a pixel (for example, the second-type pixel) other than a particular pixel (for example, the first-type pixel) out of pixels configuring the pixel unit.

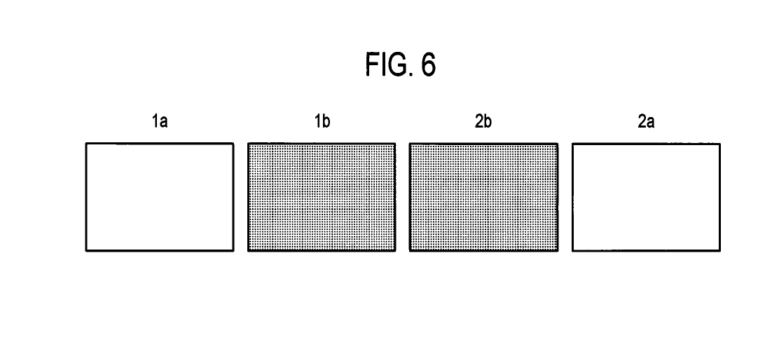

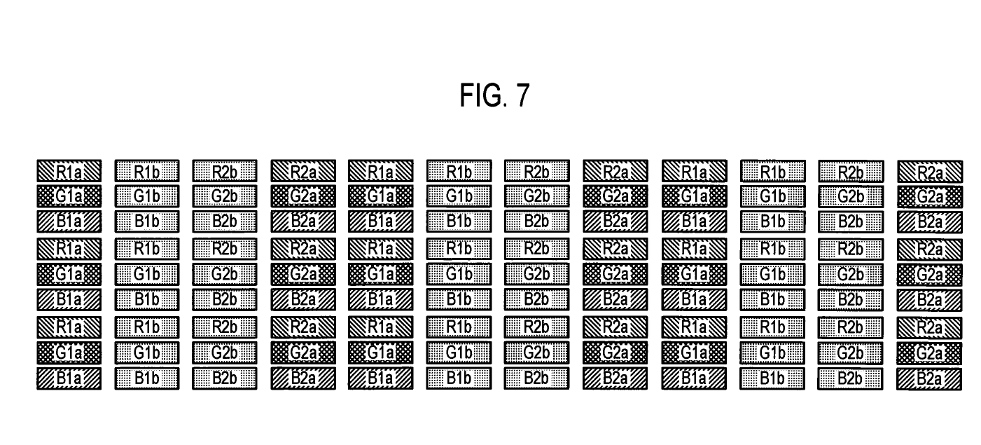

For example, description will be exemplarily made for a case where a plurality of viewpoint images (including the left-eye viewpoint image and the right-eye viewpoint image) are displayed using the first-type pixel as illustrated in FIG. 6 and FIG. 7. In this case, the image control unit controls the image display unit 10 so as to display a black image using the second-type pixel. In addition, a white image may be displayed using the first-type pixel.

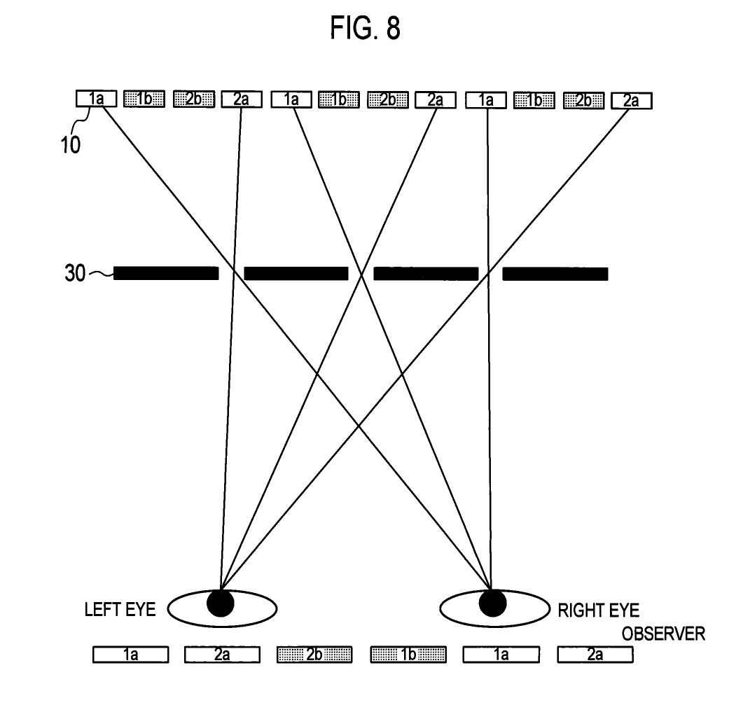

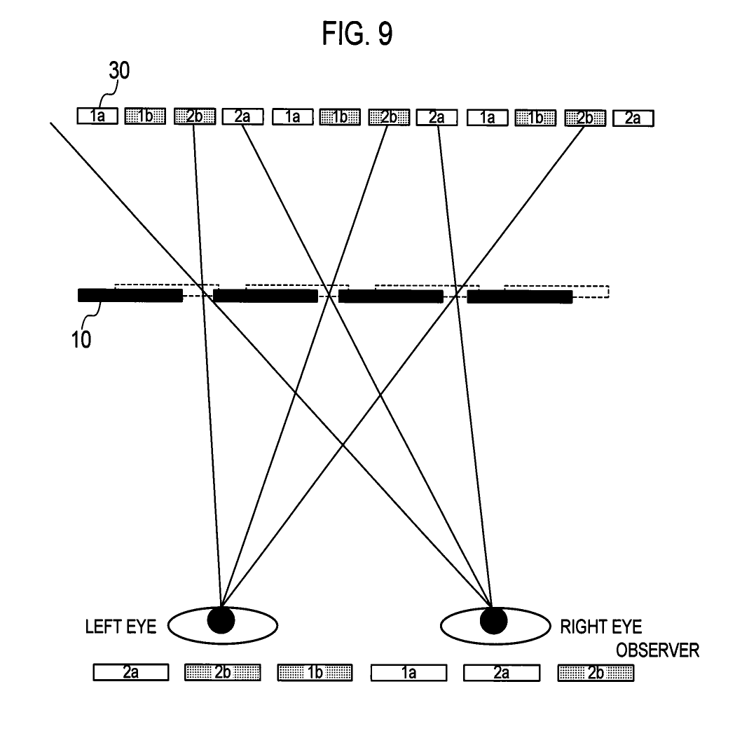

As illustrated in FIG. 8, if the position of the image separation unit 30 is correct, an observer visually recognizes a plurality of viewpoint images (including the left-eye viewpoint image and the right-eye viewpoint image) displayed in the first-type pixel. In comparison, as illustrated in FIG. 9, if the position of the image separation unit 30 is deviated, an observer visually recognizes a black image displayed in the second-type pixel.

### (Operation and Effect)

In the first modification, an image indicating whether or not the position of the image separation unit 30 is correct is displayed using a pixel (for example, the second-type pixel) other than a particular pixel (for example, the first-type pixel). Therefore, it is possible to easily correct the positional deviation of the image separation unit 30.

### Second Modification

Hereinafter, a second modification of the first embodiment will be described. The following description will be made by focusing on the differences from the first modification.

In the first modification, the image control unit controls the image display unit 10 so as to display an image indicating whether or not the position of the image separation unit 30 is correct, using a pixel (for example, the second-type pixel) other than a particular pixel (for example, the first-type pixel) out of pixels configuring the pixel unit.

In comparison, in the second modification, the image control unit controls the image display unit 10 so as to display an image indicating a direction to which the image separation unit 30 should be moved, using a pixel (for example, the second-type pixel) other than a particular pixel (for example, the first-type pixel) out of pixels configuring the pixel unit.

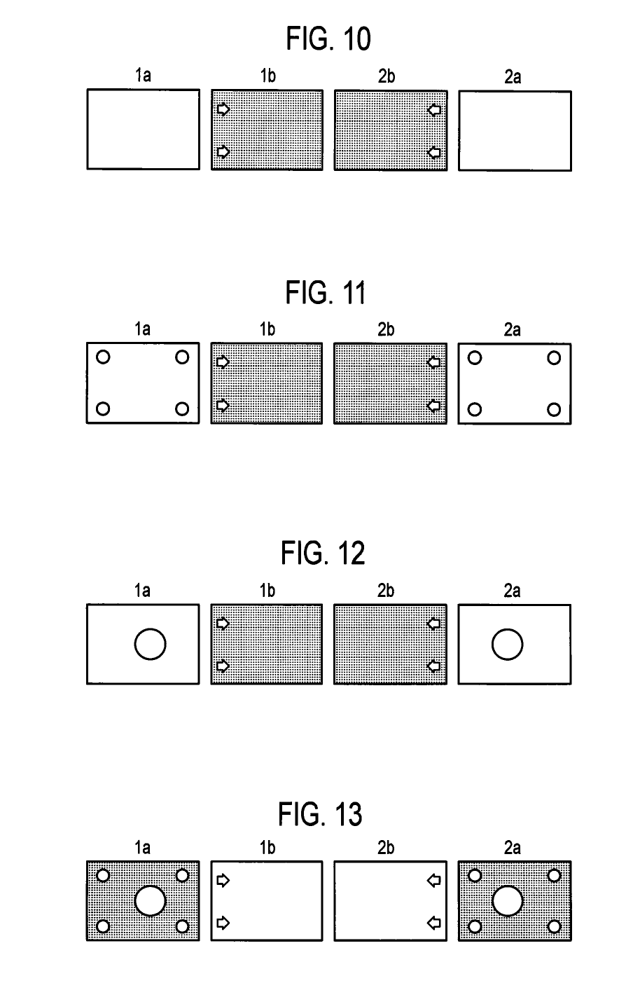

FIG. 10 to FIG. 13 illustrate exemplary images indicating the direction to which the image separation unit 30 should be moved. It should be noted that the images of FIG. 10 to FIG. 13 are the entire images (the entire frames).

For example, as illustrated in FIG. 10, as the image indicating the direction to which the image separation unit 30 should be moved, a white arrow is displayed on a black background image. In addition, the image indicating the direction to which the image separation unit 30 should be moved is displayed using a pixel (for example, the second-type pixel) other than a particular pixel (for example, the first-type pixel).

Here, if the position of the image separation unit 30 is completely deviated, the entire black image or a part of the black image is visually recognized as a two-dimensional image. If the position of the image separation unit 30 is slightly deviated, the image (indicating the arrow) displayed using the pixel of “1b” or “2b” is visually recognized as a two-dimensional image. Meanwhile, if the position of the image separation unit 30 is correct, the image (white image) displayed using the pixels of “1a” and “2a” is visually recognized.

Alternatively, as illustrated in FIG. 11, four circles may be displayed at four corners of the image using a particular pixel (for example, the first-type pixel) while the image similar to that of FIG. 10 is displayed using a pixel (for example, the second-type pixel) other than the particular pixel (for example, the first-type pixel).

Here, if the position of the image separation unit 30 is completely deviated, the entire black image or a part of the black image is visually recognized as a two-dimensional image. If the position of the image separation unit 30 is slightly deviated, the image (indicating the arrow) displayed using the pixel of “1b” or “2b” is visually recognized as a two-dimensional image. Meanwhile, if the position of the image separation unit 30 is correct, the image (the circle different from the arrow) displayed using the pixels “1a” and “2a” is visually recognized.

Alternatively, as illustrated in FIG. 12, a single circle may be displayed in the center of the image using a particular pixel (for example, the first-type pixel) while the image similar to that of FIG. 10 is displayed using a pixel (for example, the second-type pixel) other than a particular pixel (for example, the first-type pixel). In addition, the circle displayed using the first-type pixel has parallax.

Here, if the position of the image separation unit 30 is completely deviated, the entire black image or a part of the black image is visually recognized as a two-dimensional image. If the position of the image separation unit 30 is slightly deviated, the image (arrow) displayed using the pixel of “1b” or “2b” is visually recognized as a two-dimensional image. Meanwhile, if the position of the image separation unit 30 is correct, the image (the circle) displayed using the pixels of “1a” and the pixels of “2a” are visually recognized in a stereoscopic view.

Alternatively, as illustrated in FIG. 13, an arrow may be displayed on a white background image as an image indicating the direction to which the image separation unit 30 should be moved. In addition, the image indicating the direction to which the image separation unit 30 should be moved is displayed using a pixel (for example, the second-type pixel) other than a particular pixel (for example, the first-type pixel). In addition, a plurality of white circles are displayed on a black background image using a particular pixel (for example, the first-type pixel). In addition, the white circle displayed in the center using the first-type pixel has parallax.

Here, if the position of the image separation unit 30 is completely deviated, the entire white image or a part of the white image is visually recognized as a two-dimensional image. If the position of the image separation unit 30 is slightly deviated, the image (the arrow) displayed using the pixel of “1b” or “2b” is visually recognized as a two-dimensional image. Meanwhile, if the position of the image separation unit 30 is correct, the image (the center white circle) displayed using the pixels of “1a” and “2a” is visually recognized in a stereoscopic view.

### (Operation and Effect)

In the second modification, an image indicating the direction to which the image separation unit 30 should be moved is displayed using a pixel (for example, the second-type pixel) other than a particular pixel (for example, the first-type pixel). Therefore, it is possible to easily correct the positional deviation of the image separation unit 30.

### Third Modification

Hereinafter, a third modification of the first embodiment will be described. The following description will be made by focusing on the differences from the first modification.

In the first modification, the image control unit controls the image display unit 10 so as to display an image indicating whether or not the position of the image separation unit 30 is correct, using a pixel (for example, the second-type pixel) other than a particular pixel (for example, the first-type pixel) out of pixels configuring the pixel unit. In comparison, in the third modification, the image control unit controls the image display unit 10 so as to display the image for aligning the position of the image separation unit 30.

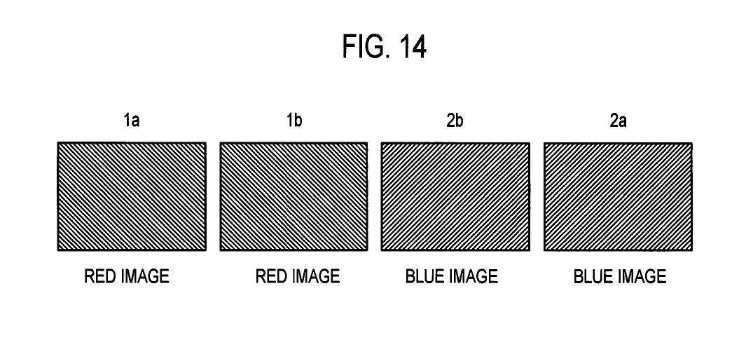

Here, FIG. 14 illustrates an exemplary image for aligning the position of the image separation unit 30. It should be noted that the image illustrated in FIG. 14 shows the entire image (the entire frame).

For example, as illustrated in FIG. 14, a red image and a blue image are displayed as the image for aligning the position of the image separation unit 30. The pixels of “1a” and “1b” are used to display the red image. The pixels “2a” and “2b” are used to display the blue image.

Here, if the position of the image separation unit 30 is deviated, the (blue) image displayed by the pixels of “2a” and “2b” is visually recognized with both eyes. Alternatively, if the position of the image separation unit 30 is deviated, the (red) image displayed by the pixels of “1a” and “1b” is visually recognized with both eyes. If the position of the image separation unit 30 is correct, the (blue and red) images displayed by the pixels of “1a” and “2a” are visually recognized with both eyes.

### (Operation and Effect)

In the third modification, the image for aligning the position of the image separation unit 30 is displayed. Therefore, it is possible to easily correct the positional deviation of the image separation unit 30.

### Fourth Modification

Hereinafter, a fourth modification of the first embodiment will be described. The following description will be made by focusing on the differences from the first embodiment.

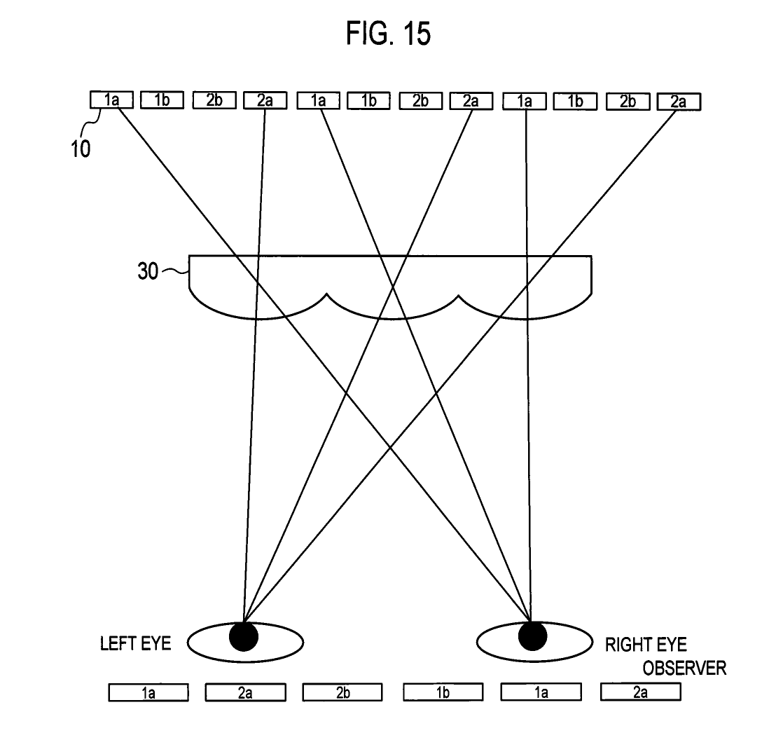

Specifically, in the first embodiment, description has been exemplarily made for a case where a parallax barrier is used as the image separation unit 30. In comparison, in the fourth modification, as illustrated in FIG. 15, a lenticular lens is used as the image separation unit 30.

### Fifth Modification

Hereinafter, a fifth modification of the first embodiment will be described. The following description will be made by focusing on the differences from the first embodiment.

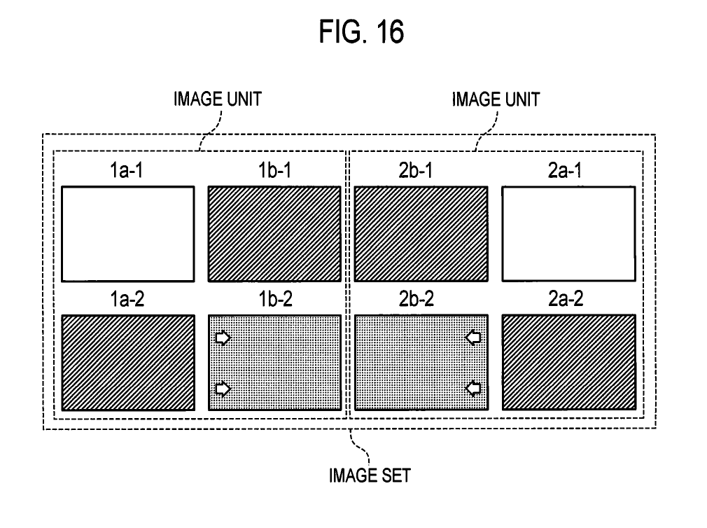

Specifically, in the first embodiment, two pixels configure a pixel unit, and two pixel units configure a pixel set. In comparison, in the fifth modification, as illustrated in FIG. 16, four pixels configure a pixel unit, and two pixel units configure a pixel set.

The number of pixels configuring a pixel unit in the vertical direction is not limited to “2”. The number of pixels configuring a pixel unit in the vertical direction may be “3” or more.

### Sixth Modification

Hereinafter, a sixth modification of the first embodiment will be described. The following description will be made by focusing on the differences from the first embodiment.

Specifically, in the first embodiment, two pixels neighboring the horizontal direction configure a pixel unit. In comparison, in the sixth modification, three pixels neighboring the horizontal direction configure a pixel unit. In addition, four or more pixels neighboring the horizontal direction may configure a pixel unit.

### (Case Where Same Image is Displayed in First-Type Pixel, Second-Type Pixel, and Third-Type Pixel)

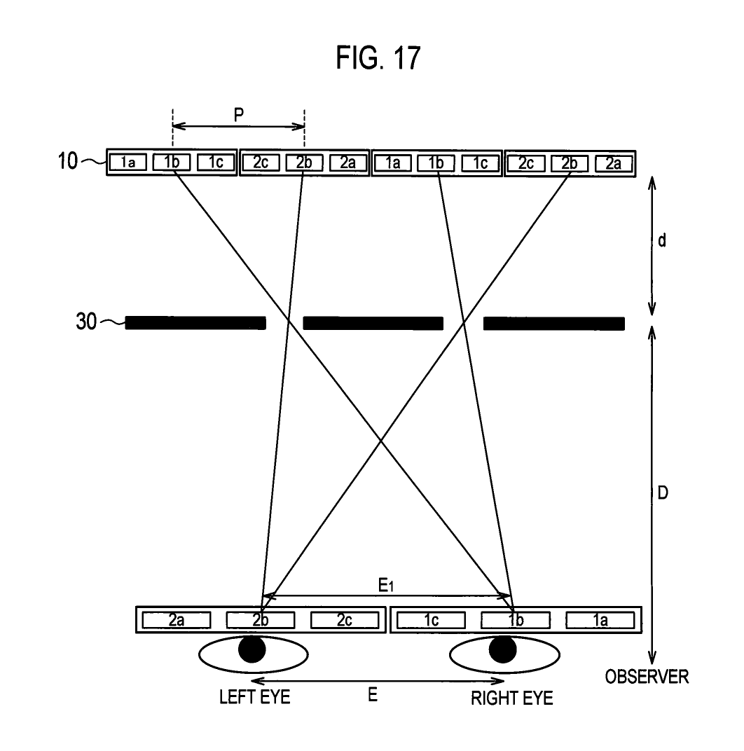

In this case, as illustrated in FIG. 17, provided that the pixel unit is regarded as a single unit, the left-eye viewpoint images and the right-eye viewpoint images are sequentially displayed along the horizontal direction.

In this case, since three pixels neighboring the horizontal direction configure a single pixel unit, the inter-pixel distance “P” increases compared to the case of FIG. 4. Therefore, it is possible to decrease the observation distance “D”. However, the interfocal distance “E₁” is equal to the interocular distance “E”.

### (Case Where Different Images are Displayed in First-Type Pixel, Second-Type Pixel, and Third-Type Pixel)

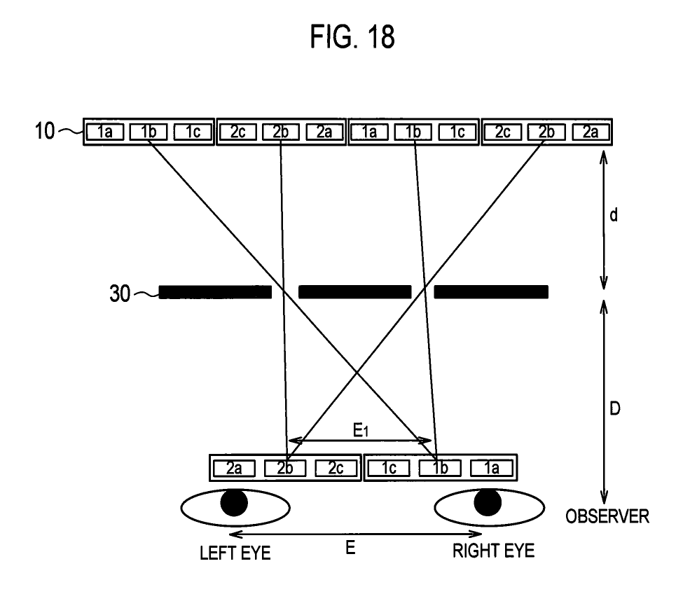

In this case, the left-eye viewpoint image and the right-eye viewpoint image are displayed in a particular pixel (the first-type pixel, the second-type pixel, or the third-type pixel). Here, description will be exemplarily made for a case where the left-eye viewpoint image and the right-eye viewpoint image are displayed in the second-type pixel. As illustrated in FIG. 18, an observer visually recognizes the second-type pixel only.

In this manner, since an observer visually recognizes only the first-type pixel, the interfocal distance “E₁” is decreased than the interocular distance “E”. For example, the interfocal distance “E₁” is ⅗ of the interocular distance “E”. Therefore, it is possible to decrease the observation distance “D”.

Similar to the case of FIG. 17, the inter-pixel distance “P” also increases in the case of FIG. 18. Therefore, it is possible to decrease the observation distance “D”. In this design state, the same image as the image to be displayed in the second type pixel may be displayed in all types of pixels.

### Other Embodiments

While the present invention has been described by the embodiments above, description and drawings as a part of this disclosure are not intended to limit the present invention. From this disclosure, various alternative embodiments, examples, and application techniques will be apparent to those skilled in the art.

In the embodiments, description has been exemplarily made for a case where a plurality of viewpoint images configuring the three dimensional image include the left-eye viewpoint image and the right-eye viewpoint image. However, the embodiments are not limited thereto. For example, a plurality of viewpoint images may include three or more viewpoint images. Three or more viewpoint images are sequentially displayed along the horizontal direction, using a plurality of pixel units, provided that the pixel unit is regarded as a single unit.

Although not particularly described in the embodiments, the image for aligning the position of the image separation unit 30 may be used by an observer to check the observation position if the image separation unit 30 is fixed.

In the embodiments, description has been made for a case where a stripe type parallax barrier is used as the image separation unit 30, in which a slit extending in the vertical direction is used as an optical transparent region (viewable area). However, it is possible to use, as the image separation unit 30, a barrier having a slit extending in an inclined direction as the optical transparent region (viewable area) or a step barrier having a step-like optical transparent region (viewable area). In this case, since the sub-pixel is the minimum unit for dividing the image, the “pixel unit” used herein may be alternatively referred to as a “pixel unit” including a plurality of pixels neighboring the horizontal direction.

What is claimed is:

1. A display apparatus that displays a three dimensional image configured by a plurality of viewpoint images, the display apparatus comprising:
an image display unit having a plurality of pixels arranged in horizontal and vertical directions; and
an image control unit that controls the image display unit, wherein
each of the plurality of pixels includes a plurality of sub-pixels arranged in the vertical direction, and
the image control unit controls the image display unit so as to sequentially display a plurality of the viewpoint images along the horizontal direction, using a plurality of pixel units, provided that each of the pixel units is regarded as a single unit configured by a plurality of pixels neighboring the horizontal direction.

2. The display apparatus according to claim 1, wherein each of the plurality of sub-pixels has a horizontal size larger than the vertical size.

3. The display apparatus according to claim 1, wherein the image control unit controls the image display unit so as to display a plurality of the viewpoint images using a particular pixel out of pixels configuring the pixel unit.

4. The display apparatus according to claim 3, wherein the image control unit controls the image display unit so as to display an image indicating whether or not a position of an image separation unit arranged between the image display unit and an observer is correct, using a pixel other than the particular pixel out of pixels configuring the pixel unit.

5. The display apparatus according to claim 3, wherein the image control unit controls the image display unit so as to display an image indicating a direction to which an image separation unit arranged between the image display unit and an observer should be moved, using a pixel other than the particular pixel out of pixels configuring the pixel unit.
